(19) United States
(12) Patent Application Publication
(10) Pub. No.: US 2025/0004995 A1
(43) Pub. Date: Jan. 2, 2025

(54) CONTENT CHANGE MONITORING

(71) Applicant: INTERNATIONAL BUSINESS MACHINES CORPORATION, ARMONK, NY (US)

(72) Inventors: Melanie Dauber, Oceanside, NY (US); Jeremy R. Fox, Georgetown, TX (US); Zachary A. Silverstein, Georgetown, TX (US); Jacob Ryan Jepperson, St. Paul, MN (US); Logan Bailey, Atlanta, GA (US)

(21) Appl. No.: 18/343,775

(22) Filed: Jun. 29, 2023

(51) Int. Cl. G06F 16/18; G06F 16/176; H04L 65/401

(52) U.S. Cl. CPC G06F 16/1873; G06F 16/176

(57) ABSTRACT

A method, computer system, and a computer program product for content change monitoring. Exemplary embodiments may include detecting a change made to a collaborative document and extracting one or more features from the change. Exemplary embodiments may further include determining a reasoning for the change based on the extracted features and quantifying an importance of the change.

### BACKGROUND

The exemplary embodiments relate generally to document versioning and backup, and more particularly to content change monitoring and explanation.

Content change monitoring is an important process for understanding how content evolves over time. By tracking changes to audio, visual, and textual content, users can gain a better understanding of how their content is evolving and why certain changes were made.

### SUMMARY

Exemplary embodiments disclose a method, a structure, and a computer system for content change monitoring. The exemplary embodiments may include detecting a change made to a collaborative document and extracting one or more features from the change. Exemplary embodiments may further include determining a reasoning for the change based on the extracted features and quantifying an importance of the change.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts an exemplary block diagram depicting the components of computing environment 100, in accordance with the exemplary embodiments.

FIG. 2 depicts an exemplary flowchart 200 illustrating operations of content change monitor 150 of computing environment 100, in accordance with the exemplary embodiments.

### DETAILED DESCRIPTION

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

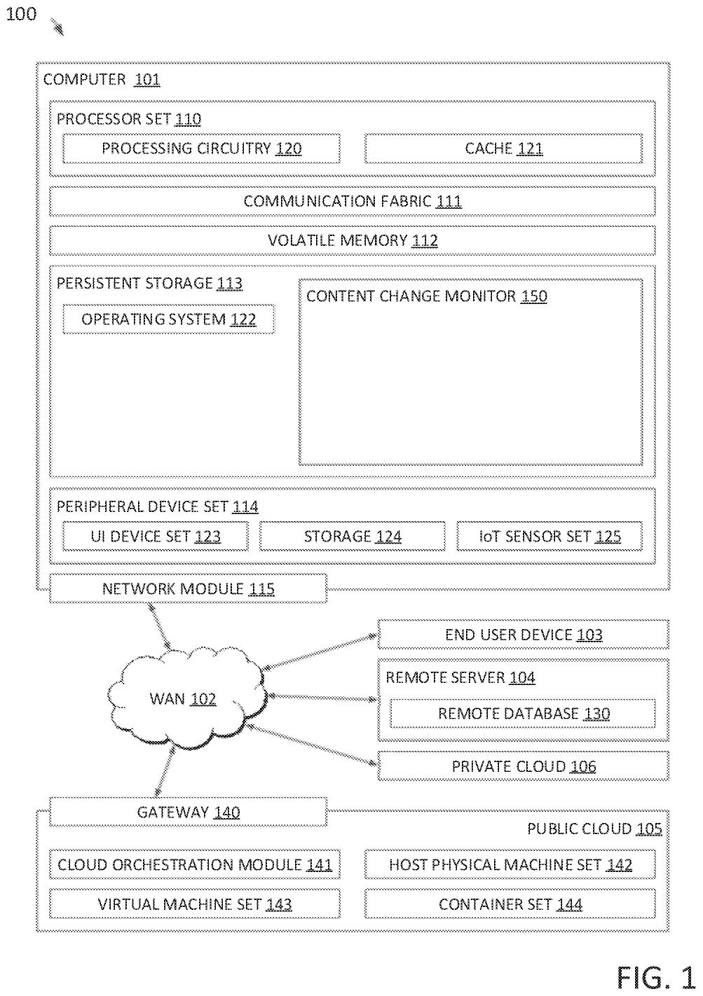

FIG. 1 depicts an exemplary block diagram depicting the components of computing environment 100, in accordance with the exemplary embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as content change monitor 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication Fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above with respect to computer 101. The EUD 103 may further include any components described with respect to computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

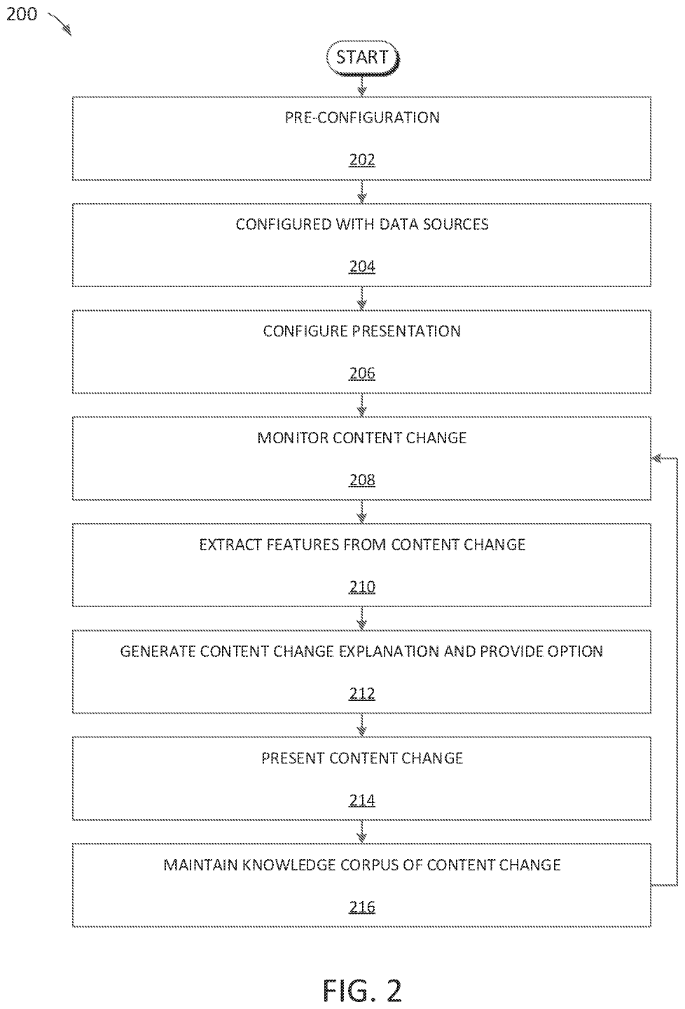

FIG. 2 depicts an exemplary flowchart 200 illustrating the operations of content change monitor 150 of computing environment 100, in accordance with the exemplary embodiments.

Content change monitoring is an important process for understanding how content evolves over time. By tracking changes to audio, visual, and textual content, users can gain a better understanding of how their content is evolving and why certain changes were made.

Organizations are increasingly relying on digital content to collaborate, reach their customers, and drive their business objectives. However, understanding the changes that have been made to content by other collaborators is often a time-consuming and highly manual process. As a result of this, organizations struggle to accurately track and quantify the changes that have been made, as well as explain why those changes were made (when, where, how, why, who, etc.).

This can lead to confusion and a lack of clarity around content changes, resulting in a suboptimal experience for developers and customers alike. The challenge is to develop an automated system that can accurately track and understand changes to content, quantify the importance and value of the change, and provide an explanation as to why the changes were made. Such a system would enable organizations to quickly and easily understand how their content is evolving over time and why certain changes were made. By storing the content changes and rationale behind them, reasoning behind content changes made by collaborators that have moved on to other roles or are otherwise no longer available may simply be referenced rather than remain unanswered.

Embodiments of the present invention will enable users to easily track changes made to content and understand why those changes were made (thus quantifying the changes). Embodiments of the present invention will employ machine learning algorithms and natural language processing (NLP) to quantify the importance and value of changes, as well as explain the reasoning behind them. Embodiments of the present invention will also provide an option to present the content changes to a user via a user selection. This approach provides users with a comprehensive and easy-to-use solution for understanding the changes (quantifying them) that have been made to their content. By tracking changes and providing a playback option presenting the changes, users can gain a better understanding of how their content is evolving and why certain changes were made.

For example, embodiments of the present invention allow for a collaborator who has not collaborated on a document in multiple revisions to review all (or important) content changes in a quick and efficient manner. In an exemplary scenario, a collaborator seeking to catch up to a current version of a document may click through brief explanations of the content changes made by colleagues. This feature presents an improvement over the current state of the art in which the collaborator in the above example would otherwise be required to tediously sort through tracked content changes of each revision until arriving at the current version. In another scenario, a newly appointed board may avoid rehashing of topics discussed by the former board via reference to a content change log and explanations thereof.

Reference is now made to the FIG. 2 flowchart. In embodiments, content change monitor 150 may implement a training phase in which it is trained, denoted by the configuring steps described forthcoming, then an application phase in which it is deployed. In the application phase, content change monitor 150 may be installed as a client on a user device within a client-server relationship where the client provides a user interface for interacting with content change monitor 150.

Content change monitor 150 may be pre-configured (step 202). Content change monitor 150 may initially receive a configuration that establishes the machine learning (ML) and natural language processing (NLP) components thereof. In order to detail content changes made by one or more collaborators to a collaborative document, content change monitor 150 must be configured with machine learning algorithms and a natural language processing (NLP) engine that are capable of identifying the changes and extracting features therefrom. In embodiments, content change monitor 150 may extract from changed content a 1) who made the change, 2) what change was made, 3) why the change was made, 4) where the change was made, 5) a when the change is made, 6) a how the change is made, and 7) an importance. Some of these features may be readily available to content change monitor 150. For example, the who can be extracted from login credentials of a user making the change, the when can be determined based on a timestamp associated with the change, and the what and the how can be determined based on the detected changes, for example from comparing version histories. Content change monitor 150 must determine, however, the why a content change was made, from which an importance may be further deduced. In order to determine the why, the NLP engine may be configured to extract textual features, such as words/sentences and language analysis, while the ML algorithm may be configured to extract non-textual features, such as images and other multimedia, all of which may be helpful in determining the why with respect to a content change.

In addition to extracting non-textual features, the ML algorithm may be additionally configured to receive the extracted features as input and output a most likely why/reasoning for the content change. During training, the ML algorithm may analyze features from previous content changes having a labeled rationale behind them in order to identify content change patterns. The rationale behind the content changes may be, for example, user solicited or found within a comments section associated with a content change and may include reasons for the content change such as typo fixes, grammatical fixes, personal preference, community preference, etc. (it should be noted that fixes such as typos and grammar may be detected by the NLP engine in addition to being labeled). The changes may be, for example, syntactical where the rationale explains that one phrasing is more technically accurate. Other content changes may be attributed to user preference, for example a font or color change. Further content changes may be based on industry standard, for example red delineating a negative outcome. In order to capture patterns such as those listed above, the training of the ML algorithm may include uploading different versions of content having content changes and associated explanations for the content changes (i.e., the why). The ML algorithm may then weight the features based on relevance to the why and once trained, then be applied to new content changes in order to identify a most likely why based on historic patterns of features without the need for collaborator explanation (i.e., labels).

Reference is now made to an illustrative example in which content change monitor 150 configures an NLP engine to extract textual features from detected content changes and an ML algorithm to extract non-textual features from the detected content changes. In addition, the ML algorithm is further configured to receive the extracted features and labeled rationales as input in order to output a reasoning as to why the content changes were made.

Content change monitor 150 may be configured with data sources (step 204). In embodiments, content change monitor 150 may be configured with data sources that provide the labeled training data used in training the ML algorithm and NLP engine. For example, the data sources may include revision histories that detail document changes over time and labeled rationales behind the changes. The labeled rationales may be in an associated comments section, solicited from a user who made the changes, determined via analysis, for example with the use of techniques capable of identifying typos and grammatical errors, etc. The training data may be sourced from any number of documents and may be specific to a user or group of users. For example, the NLP engine and ML algorithm may be trained using training data specific to a collaborator to detect their respective style, for example a user may prefer a particular font as determined from their document version changes. In addition, the NLP engine and ML algorithm may be trained based on training data from a community at large, for example developers within a particular technical field that prefer the use of a particular synonym based on analysis of their document revision histories. As such, the NLP engine and ML algorithm may be capable of determining why a content change is made in the subjective context of a particular collaborator as well as an objective context of a group. Such granularity allows for content change monitor 150 to attribute the why of some content changes merely to person preference as opposed to other, more significant reasoning.

In addition, content change monitor 150 may be configured with the data sources for which content monitoring is desired. These data sources may be any collaborative document in which multiple collaborators edit a single document or versions thereof. As such, content change monitor 150 may be linked to collaborative files, folders, databases, etc. in which content changes by multiple users require monitoring.

In the previously introduced example, and assuming content change monitor 150 is implemented for a software development company, content change monitor 150 may be linked to training data that includes revision histories for documents edited by developers at the software development company. In addition, content change monitor 150 may be linked to collaborative working platforms that the company uses to collaboratively develop company documents, such as a collaborative word processing platform.

Content change monitor 150 may configure a presentation (step 206). In embodiments, content change monitor 150 configures a presentation that presents the content changes, provides context to the changes, and explains the reasoning behind them. Content change monitor 150 may further generate a replay or playback button that allow users to display the presentation manually. The configuration may include customizable options that determine when to present content changes, what changes to announce, and a desired presentation medium. In embodiments, there may be several scenarios during which content changes may be presented to a collaborator. In a first scenario, a first collaborator makes changes to content within a collaborative document and a second collaborator reviews the document at a subsequent time. In this first scenario, the second collaborator may configure content change monitor 150 to present content changes for the second collaborator at the subsequent time based on proximity to the content change (e.g., scrolling through the content change) or the selection of the generated replay button. In a second scenario, a first collaborator may change content simultaneous to a second collaborator editing a same collaborative document. In this second scenario, content change monitor 150 may be configured to present the content changes in real time. Similarly, content change monitor 150 may provide a push notification presenting the content changes in real-time to collaborators. The configuration may further include an extent to which the presentation details the detected content changes. In embodiments, a user may select for presenting any selection of a who, what, why, where, when, how, and importance as it relates to a detected content change. In addition to selecting which of the features to be presented above, content change monitor 150 may be further configured with thresholds to filter the presented content changes, for example those made by a particular collaborator, those made at a particular time, or those exceeding a threshold importance. The configuration may further include a preferred medium by which to present the changes, such as a selection of audio, text, and video multimedia detailing the content changes. Thus, the configuration may include a timing of the content change presentation, a depth of content change detail, and a medium by which the content change is preferably presented.

In the example previously introduced, content change monitor 150 may be configured to present changes to a subsequent reviewer of a collaborative document using a slideshow where a fellow collaborator may click through content changes exceeding a threshold importance at their own pace.

Content change monitor 150 may monitor content changes (step 208). In embodiments, content change monitor 150, now in the application phase, may detect content changes such that the changes can be logged and subsequently explained as needed to collaborators of the document. Detecting a content change is the first step in determining the who, what, why, where, when, how, and importance of the content change. Content change monitor 150 may detect changes made to content in a variety of manners, for example utilizing a task mining agent, utilizing file differencing algorithms analyzing content at save points, or combination of both. In addition, content change monitor 150 may detect content changes utilizing version control systems, establishing clear workflow approval processes, implementing content review cycles with multiple checkpoints, using automated processes in the content management platform, using content audit and analytics tools to spot trends and highlight areas of improvement, and tracking content changes through detailed version histories. Content change monitor 150 may further monitor content changes in an editing environment to capture and log the user input data, measure differences at save, or content repositories may utilize parent-child relationships, versioning metadata, etc. to store document version changes. In a collaborative environment such as a sync and share in a cloud environment, a use case may be running a file differencing algorithm periodically or at save points. In a repository where a user may check out, edit locally, and check in changes, task capture log data may provide the optimal data for generating a step through simulation of changes. In general, content change monitor 150 may use a variety of techniques to detect changes to content.

Continuing the example above, content change monitor 150, now in application phase, detects a content change made to a first version of a document by a first developer, resulting in a second version of the document, as well as two additional content changes made to the second version of the document by a second collaborator, resulting in a third version of the document having three content changes. The first content change fixes a typo, the second content change alters numeric text within a table, and the third content change changes a font.

Content change monitor 150 may extract features from the content change (step 210). In embodiments, content change monitor 150 may extract a who, what, why, where, when, how, and importance with respect to each content change. As described above, content change monitor 150 may determine a why or reasoning/rationale behind a content change using the NLP engine and ML algorithm trained above. In embodiments where content change monitor 150 computes a sub-threshold confidence in why a collaborator has committed a content change, content change monitor 150 may be configured to prompt the collaborator for user input indicative of why the change was made in real time. In addition, content change monitor 150 may extract a who made the content change based on the login credentials of a user committing the content change and a when based on a timestamp associated with the content change. In addition, content change monitor 150 may extract a what, where, and how based on the detected content changes described above. For example, the what may be the changed content such as text, the where may be the location of the changed text such as column and line number of a document (and may additionally include the location of the collaborator who changed the content), and the how may be the manner of the change such as adding, replacing, removing, etc. Content change monitor 150 may additionally extract features using the NLP engine, for example to extract a semantic meaning of the sentence, a syntax, fixes to typos and grammatical errors, etc.

Content change monitor 150 may further quantify an importance of the content changes. In embodiments, content change monitor 150 may utilize the NLP engine and ML algorithm to determine an importance of the content change. The importance may be reflected in weights associated with the features during the training phase and may connote additional importance for changes made based on historic importance. For example, correction of typographical and grammatical errors may carry little weight for importance while changes made to the body text or equations may be considered of higher importance. Importance may be further deduced from the training data or user input, for example a content change that is accompanied by an explanation of importance within a comment. In such cases, the NLP engine may be used to extract language connoting importance, for example using keyword searching and negation analysis.

Content change monitor 150 may further log the content changes and context thereof within a content change log. The content change log may include the who, what, where, why, when, how, and importance to enrich the document revision history and allow for retrieval of the content change presentations. The content change log may be further used as training data for content change monitor 150 in order to increase the training data on which it is based.

Returning to the previously introduced example, content change monitor 150 extracts a who, what, where, why, when, how, and importance of the three content changes made by the first and second developers. Content change monitor 150 determines that the first content change is merely correcting a typo based on identifying an incorrectly spelt word being replaced with the word spelt correctly and assigns a low importance value based on typo corrections having historically low significance. Content change monitor 150 additionally determines that the content change to the numerals of the table is a data correction based on the content change being in a tabulated form and assigns a high importance as a result of numeric data historically holding high importance at the web development company. Content monitor 150 lastly determines that the third content change to font is preferential to the second developer based on consistent use by them personally, and therefore assigns a low importance value.

Content change monitor 150 may generate a content change explanation and provide an option to present the content change (step 212). Content change monitor 150 may generate an explanation of the content change that provides the who, what, why, where, when, how, and importance of the content change, depending on a configuration selected by the user. The explanation may be as simple as indicating that there was a typo or grammatical error, or as complex as changing to a preferred wording or formatting, for example an industry standard. In addition to any automatic presentation preferences set by the user during configuration, the presentation may be available for replay whenever needed, enabling users to quickly and easily understand how their content is evolving over time and why certain changes were made.

In the previously introduced illustrative example, content change monitor 150 generates a textual and/or audial presentation of each of the three content changes made that include screenshots of the before and after of the content changes along with brief textual explanations thereof.

Content change monitor 150 may present the content change (step 214). Utilizing the pre-configured announcer, content change monitor 150 may provide an explanation of the content changes that were made. Depending on the configuration set forth above, the presentation will provide context to the changes and explain the reasoning behind them, which may include the who, what, where, why, when, how, and importance. The announcement may be via audio, visual, or both mediums and include before and after screenshots and/or simulations.

With reference again to the illustrative example, if an original creator of the first version of the document wishes to see the content that has changed between the first version they created and the now current third version, the content change monitor 150 presents the three content changes to the creator in a slideshow presentation where the creator can view or listen to a context of the content changes. In embodiments where the creator only wishes to see content changes exceeding a threshold importance, content change monitor 150 may only present the content changes to the numeric characters of the table that were deemed high importance.

Content change monitor 150 may maintain a knowledge corpus of the content change (step 216). In embodiments, content change monitor 150 develops a knowledge corpus that will be used to store the context of the changes that have been made to the content. The knowledge corpus may log, with respect to the content change, the who, what, when, where, why, how, importance, and any explanations. This knowledge corpus will provide users with an understanding of the changes that have been made and why they were made. The knowledge corpus may additionally also be used to store the extracted text from the content changes, which will be used to quantify the importance and value of the change and explain why it was made. The knowledge corpus will be managed using a database management system. This system will ensure that the data is organized and can be easily accessed and updated whenever needed. The knowledge corpus will be maintained regularly to ensure that the changes are accurately tracked and explained, as the user interacts with content. This will enable users to quickly and easily understand how their content is evolving over time and why certain changes were made.

Concluding the illustrative example, content monitor 150 archives the context of the three content changes within the knowledge corpus for subsequent reference.

1. A computer-implemented method for content change monitoring, the method comprising:
detecting a change made to a collaborative document;
extracting one or more features from the change;
determining a reasoning for the change based on the extracted features, wherein the reasoning distinguishes personal preference of a collaborator making the change from an industry standard; and
quantifying an importance of the change.

2. The computer-implemented method of claim 1, further comprising:
in response to receiving a user selection, displaying the change, the reasoning, and the importance.

3. The computer-implemented method of claim 2, wherein the displaying further includes audio commentary of the change, the reasoning, and the value.

4. The computer-implemented method of claim 1, wherein detecting the change is based on a comparison of version histories of the collaborative document.

5. The computer-implemented method of claim 1, wherein the reasoning is determined by training an algorithm to correlate the one or more features with one or more reasonings using historic training data.

6. The computer-implemented method of claim 1, wherein the importance is determined based on historic importance of the one or more features.

7. The computer-implemented method of claim 1, further comprising:
receiving a configuration to automatically display the change, the reasoning, and the importance.

8. A computer system for content change monitoring, comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
detecting a change made to a collaborative document;
extracting one or more features from the change;
determining a reasoning for the change based on the extracted features, wherein the reasoning distinguishes personal preference of a collaborator making the change from an industry standard; and
quantifying an importance of the change.

9. The computer system of claim 8, further comprising:
in response to receiving a user selection, displaying the change, the reasoning, and the importance.

10. The computer system of claim 9, wherein the displaying further includes audio commentary of the change, the reasoning, and the value.

11. The computer system of claim 8, wherein detecting the change is based on a comparison of version histories of the collaborative document.

12. The computer system of claim 8, wherein the reasoning is determined by training an algorithm to correlate the one or more features with one or more reasonings using historic training data.

13. The computer system of claim 8, wherein the importance is determined based on historic importance of the one or more features.

14. The computer system of claim 8, further comprising:
receiving a configuration to automatically display the change, the reasoning, and the importance.

15. A computer program product for content change monitoring, comprising a computer-readable storage medium having program instructions embodied therewith, the program instructions executable by a processor to cause the processor to perform a method comprising:
detecting a change made to a collaborative document;
extracting one or more features from the change;
determining a reasoning for the change based on the extracted features, wherein the reasoning distinguishes personal preference of a collaborator making the change from an industry standard; and
quantifying an importance of the change.

16. The computer program product of claim 15, further comprising:
in response to receiving a user selection, displaying the change, the reasoning, and the importance.

17. The computer program product of claim 16, wherein the displaying further includes audio commentary of the change, the reasoning, and the value.

18. The computer program product of claim 15, wherein detecting the change is based on a comparison of version histories of the collaborative document.

19. The computer program product of claim 15, wherein the reasoning is determined by training an algorithm to correlate the one or more features with one or more reasonings using historic training data.

20. The computer program product of claim 15, wherein the importance is determined based on historic importance of the one or more features.
